(19) United States
(12) Patent Application Publication
(10) Pub. No.: US 2022/0293075 A1
(43) Pub. Date: Sep. 15, 2022

(54) MULTIMEDIA TRANSPORTER AND MULTIMEDIA TRANSPORTER SYSTEM FOR A MODULAR PIANO KEYBOARD

(71) Applicant: POCKETPIANO, S.L., Barcelona (ES)

(72) Inventor: Josep BERGADA BOMBI, Barcelona (ES)

(21) Appl. No.: 17/753,059

(22) PCT Filed: Dec. 5, 2020
(86) PCT No.: PCT/ES20/70768

§ 371 Date: Feb. 16, 2022

(30) Foreign Application Priority Data
Dec. 13, 2019 (ES) U 201932052

(51) Int. Cl. G10H 5/00; G10H 1/06

(52) U.S. Cl. CPC G10H 5/00; G10H 1/06

(57) ABSTRACT

Different aspects of the invention implement a multimedia transporter system configured to accommodate a disassembled modular piano keyboard, and at the same time, configured to enhance the sound and user experience once the modular piano keyboard is assembled and played. Thus, the system comprises a multimedia transporter and a modular piano keyboard, optionally with pedals. A corresponding method is implemented in a multimedia transporter, as well as in the system, in addition to a computer program and a computer-readable medium, both comprising instructions that, once executed on a processor, carry out the method in the multimedia transporter system.

### TECHNICAL FIELD

The invention is generally located in the field of electronic musical instruments, and, in particular, to a multimedia transporter for a modular keyboard.

### BACKGROUND ART

There are electronic musical instruments that reproduce a variety of sounds. Among these are electronic keyboards incorporating synthesizers that vary the intensity, frequency or phase parameters of a sound to reproduce a wide spectrum of sounds representing different instruments, from piano, violin, to drums, or virtual instruments that do not exist in the non-electronic real world.

There are also modular piano keyboards that have been developed so that they can be disassembled into modules for ease of transport. These modular keyboards have focused their efforts on bringing sounds from hundreds of diverse instruments to the general public for playing electronic music, and, therefore, by assembling the modules to form a complete keyboard, the feeling of playing an instrument that faithfully reproduces the actual piano sound is lost.

Therefore, there is a need to effectively solve these above-mentioned problems. The inventor has identified the need to enhance the sound generated from existing modular piano keyboards to give them the ability to reproduce the full experience of playing a real piano while maintaining the advantages of modularity and portability.

### SUMMARY OF THE INVENTION

It is an object of the invention to provide solutions to the aforementioned problems. In particular, it is an object of the invention to provide a multimedia transporter system configured to house a disassembled modular piano keyboard, and at the same time, configured to enhance the sound and user experience once the modular piano keyboard is assembled.

It is therefore an object of the invention to provide a multimedia transporter for a modular piano keyboard.

It is another object of the invention to provide a multimedia transporter system comprising a modular piano keyboard with its pedals and a multimedia transporter.

It is another object of the invention to provide a method in a multimedia transporter.

It is another object of the invention to provide a computer program comprising instructions which, once executed on a processor, carry out a method on a multimedia transporter.

It is another object of the invention to provide a computer readable medium comprising instructions which, once executed on a processor, carry out a method on a multimedia transporter.

The invention provides methods and devices that implement various aspects, embodiments, and features of the invention, and are implemented by various means. The various means may comprise, for example, hardware, software, firmware, or a combination thereof, and any one, or combination, of the various means may implement these techniques.

For a hardware implementation, the various means may comprise processing units implemented on one or more application specific integrated circuits (ASICs), digital signal processors (DSPs), digital signal processing devices (DSPDs), programmable logic devices (PLDs), in-place programmable gate arrays (FPGAs), processors, controllers, microcontrollers, microprocessors, other electronic units designed to perform described functions, or a combination thereof.

For a software implementation, the various means may comprise modules (for example, processes, functions, and so forth) that carry out the described functions. The software code may be stored in a memory unit and executed by a processor. The memory unit may be implemented within the processor or external to the processor.

Various aspects, configurations, and embodiments of the invention are described. In particular, the invention provides methods, apparatuses, systems, processors, program code, computer-readable means, and other apparatuses and elements that implement various aspects, configurations, and features of the invention, such as described in the following.

### BRIEF DESCRIPTION OF THE DRAWINGS

The features and advantages of the present invention will become more apparent from the detailed description which follows in conjunction with the drawings, in which like reference characters identify corresponding elements in different drawings. Corresponding elements may also be referenced by different characters.

FIG. 1 shows the multimedia transporter system according to one embodiment of the invention in an unassembled state.

FIG. 2 shows the multimedia transporter system according to another embodiment of the invention in an assembled state.

FIG. 3 shows a part of the disassembled modular piano keyboard and the connection of the various keyboard modules by means of magnetized connectors.

### DETAILED DESCRIPTION OF THE INVENTION

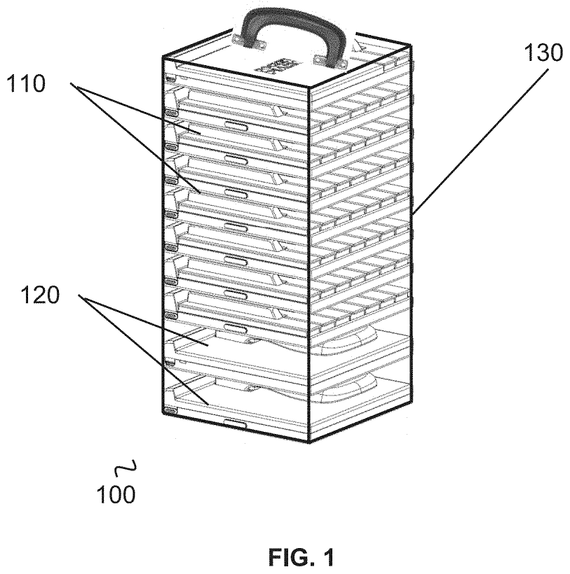

FIG. 1 shows the multimedia transporter system according to an embodiment of the invention in an unassembled state. The system 100 comprises a multimedia transporter 130 configured to house a modular piano keyboard comprising at least one keyboard module 110 and, optionally, at least one pedal module 120. In an aspect, as customarily played by classical pianists, the modular piano configuration comprises a plurality of keyboard modules, representing an 88-key piano, and two pedal modules. In an unassembled state, the main functions of the transporter are that of electrically charging the various modules while downloading the configured software or parameters if necessary.

The transporter is configured to receive and accommodate each of the modules separately, stacked vertically, although other configurations are possible, such as, for example, a horizontal rather than vertical configuration. In this way, the entire piano can be easily transported with the corresponding pedals.

In one aspect, the multimedia transporter comprises charging means for storing electrical power and driving the other components of the system. The charging means may be a rechargeable battery, and may be rechargeable via a wired or wireless connection. In one configuration, all modules are rechargeable, while in another configuration, the transporter is configured to charge only a master keyboard module and a master pedal module, as these then charge the other keyboard and pedal modules to which they are physically connected. This reduces the weight of the overall assembly of modules, making them easier to transport on the transporter. The transporter also comprises an electrical connector for connecting a cable with a plug configured to plug into the mains.

In another aspect, the transporter comprises a display for visual representations. The display can visually reproduce the notes, or keys, or music being played by the modular piano keyboard. It may also represent scores that automatically change pages as it is determined wherein the music played is located in the score. In one aspect the display may be touch-sensitive, to facilitate user interaction, either for configuration of the modular piano keyboard or to enable other functions, such as, for example, through external connectivity, recording of pieces and sending them via known social networking applications. The skilled artisan is familiar with the various modes of external connectivity, such as, for example, via WiFi, Bluetooth, Ethernet, or others.

In another aspect, the transporter comprises at least one loudspeaker for reproducing sound acoustically. In another aspect, the transporter comprises a low-pitched speaker (or subwoofer) and another high-pitched speaker. In one aspect, the speaker is further configured to reproduce sound signals received from another device, for example, a user's electronic device. Thus, the speaker can reproduce both the sound of the modular piano keyboard and at the same time externally received music, for example, an accompanying background. In another aspect the transporter comprises geolocation means configured for determining the geographic location thereof, and display it on screen.

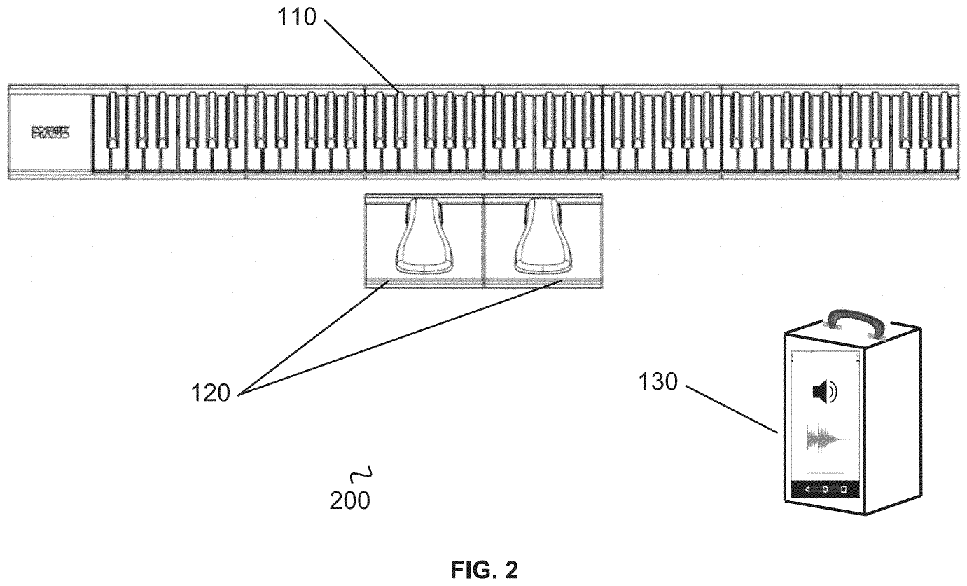

FIG. 2 shows the multimedia transporter system according to another embodiment of the invention in an assembled state. The modular piano keyboard is configured to be easily assembled by bringing one module close to another module. In the assembled state, the main function of the transporter is to receive and translate signals generated by playing the keyboard or pedal into corresponding acoustic or visual representations.

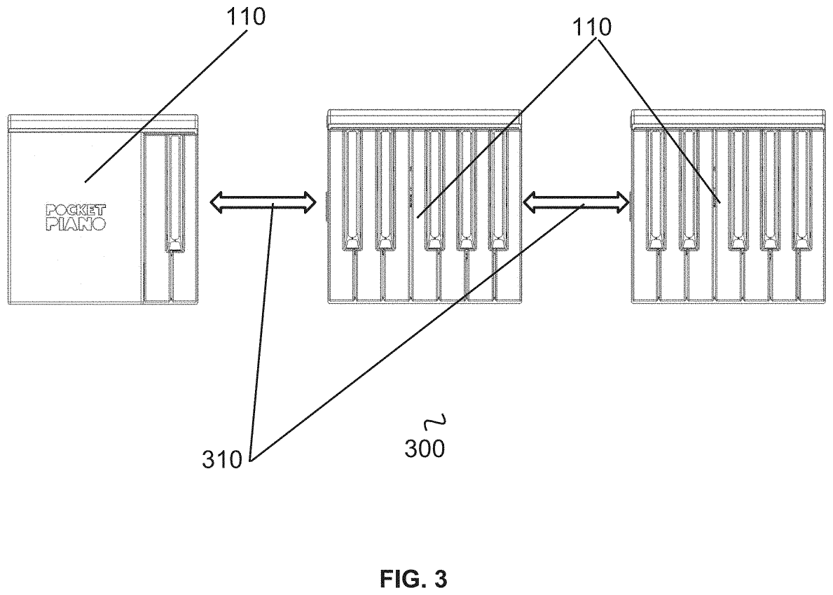

FIG. 3 shows a portion of the disassembled modular piano keyboard and the connection of the various keyboard modules by means of magnetized connectors. In one aspect of the invention, there is a master module of 3 keys connected by magnets to the other slave keyboard modules of 12 keys each. The connecting means is a magnetized connector, or magnet, which attracts and joins a first module to a second module by aligning the respective magnets of the two modules. In this aspect, connecting and disconnecting, or mounting and dismounting, or assembling or disassembling, the piano is facilitated, as it requires little expertise and strength, providing a very versatile and intuitive keyboard module for both novice users regardless of age or knowledge of state-of-the-art electronic devices.

The keyboard modules and pedal modules each comprise processing means configured to generate a signal once pressed when played. Further, the keyboard modules and pedal modules each comprise communication means configured to transmit the signal generated by the processing means to the multimedia transporter. This transmission is accomplished via a wired connection, such as a cable or physical connector, or wirelessly. The skilled artisan is familiar with the various wired and wireless connection modalities, along with their protocols, without needing to delve further into their details in this disclosure. Examples may include connectivity via USB, Wi-Fi, Bluetooth, and so on.

The multimedia transporter comprises processing means and communication means for receiving the signal and processing the signal to extract parameters contained therein. In one aspect, the processing means comprise a computer application that facilitates the interface with the user. The information comprises additionally other parameters depending on whether it comes from a keyboard module or a pedal module. The computer application is responsible for translating the information and parameters received to reproduce the function of the module from which the information in question originates. That is, to reproduce the sounds of the keys pressed on the keyboard modules and to reproduce the function of the pedals pressed on the pedal modules. Finally, the computer application reproduces sounds and/or visual representations of the user's actions. The transporter's communication means are also configured to transmit data to any external device, either by direct connection or via the internet. This transmission is accomplished via a wired connection, such as a cable or physical connector, or wirelessly. The skilled artisan is familiar with the various modes of wired and wireless connection, along with their protocols, without the need to delve further into their details in this disclosure. Examples may include connectivity via USB, Wi-Fi, Bluetooth, and so on.

In the case of the keyboard module, the software application is configured to reproduce the sound represented by the keystrokes through output interfaces. On the one hand, the output interface is a loudspeaker to reproduce the sound of the music. On the other hand, the output interface is a display to reproduce the note visually on a graphical user interface GUI. In the case of the pedal module, the software application is configured to reproduce the different functions according to the position of the pedal and to reproduce this effect together with the sound of the key press and/or also visually.

In another aspect, the transporter comprises a binaural audio processor for processing the musical information in real time. In another aspect, the multimedia processing means enables transmission, or broadcasting, of the sound in real time and as an audio stream via the internet, also via connections to various social platforms.

Therefore, the various aspects of the invention described enable enhanced user experience while playing the piano by providing a multimedia transporter for a modular piano keyboard, which is automatically configured by means of the transporter's computer application, to reproduce the sound, reproducing the feel and sound quality of a real piano.

It is further understood that the described embodiments and aspects may be implemented by various means in hardware, software, firmware, middleware, microcode, or any combination thereof. Various aspects or features described may be implemented, on the one hand, as a method or procedure or function, and on the other hand, as an apparatus, device, system, or computer program accessible by any computer-readable device, carrier, or medium. The described procedures or algorithms can be implemented directly in hardware, in a software module executed by a processor, or a combination of the two.

The various means may comprise software modules resident in RAM memory, flash memory, ROM memory, EPROM memory, EEPROM memory, registers, hard disk, removable disk, a CD-ROM, or any other type of storage medium known in the art.

The various means may comprise logic blocks, modules, and circuits may be implemented or carried out by a general purpose processor, a digital signal processor (DSP), an application specific integrated circuit (ASIC), a field programmable gate array (FPGA), or other programmable logic, discrete gate or transistor logic devices, discrete hardware components, or any combination thereof designed to carry out the described functions. A general purpose processor may be a microprocessor, but alternatively, the processor may be a conventional processor, controller, microcontroller, or state machine.

The various means may comprise computer-readable means including, but not limited to, magnetic storage devices (for example, hard disks, floppy disks, magnetic strips, and the like), optical disks (for example, CD compact disks or versatile DVDs, and the like), smart cards, and temporary flash storage drives (for example, EPROM, pen card, key drive, and the like). Additionally, the described array of storage media may represent one or more computer-readable devices and/or means for storing information. The term computer-readable medium may comprise, without being limited thereto, a variety of means capable of storing, saving, or transporting instructions and/or data. Additionally, a computer program product may comprise a computer-readable medium with one or more instructions or operating codes for causing a computer to perform the described functions once executed on the computer.

What has been described comprises one or more embodiments by way of example. It is of course not possible to describe every conceivable combination, or permutation, of the components and/or methodologies for the purpose of describing the aforementioned embodiments. Instead, the skilled artisan will realize that many other combinations and permutations of various realizations are possible within the inventive concept after a direct and objective reading of this disclosure. Accordingly, it is intended to embrace all such alterations, modifications and variations that fall within the scope of the appended claims.

In the following, certain additional aspects or examples are described:

A multimedia transporter for housing a modular piano keyboard, the modular piano keyboard comprising at least one keyboard module, and optionally, a pedal module, the transporter comprising: a frame; at least one first housing means configured to house the at least one keyboard module; at least one second housing means configured to house the at least one pedal module; communication means configured for communicating with the at least one keyboard and/or pedal module, and also configured to communicate with at least one external electronic device; a graphical interface configured for visual representations upon playing the keys and/or pedals, and/or upon receiving signals from at least one external electronic device; a loudspeaker configured for acoustic representations upon playing the keys and/or pedals, and/or upon receiving signals from at least one external electronic device.

The transporter, further comprising charging means configured to conduct electrical power to at least one housed module. The transporter, further comprising input means for receiving configuration orders or instructions from the user. The transporter, further comprising processing means configured for updating the intensity, frequency, or phase, parameters, of a sound, of each of the housed modules. The transporter, further comprising processing means configured for receiving a signal generated by the disassembled modules and for generating an acoustic, optionally visual, representation of the actions of the user playing the modular piano keyboard. The transporter, wherein the processing means are also configured for receiving a signal from an external electronic device, for example music, and for generating an acoustical, optionally visual, representation. The transporter, wherein the loudspeaker comprises means for outputting bass tones, also known as subwoofer, and means for outputting treble tones. The transporter, further comprising a binaural audio processor.

A method in a multimedia transporter of any one of the preceding claims, the multimedia transporter configured for housing a modular piano keyboard, the modular piano keyboard comprising at least one keyboard module, and optionally, a pedal module, the method comprising: communicating with the at least one keyboard and/or pedal module, and also with at least one external electronic device; visually representing, by means of a graphical interface, upon playing the keys and/or pedals, and/or upon receiving signals from the at least one external electronic device; acoustically representing, by means of a loudspeaker, upon playing the keys and/or pedals, and/or upon receiving signals from the at least one external electronic device.

The method, further comprising conducting electrical power to at least one housed module. The method, further comprising receiving configuration orders or instructions from the user. The method, further comprising updating the intensity, frequency, or phase, parameters, of a sound, of each of the housed modules. The method, further comprising receiving a signal generated by the disassembled modules and for generating an acoustic, optionally visual, representation of the actions of the user playing the modular piano keyboard. The method, comprising receiving a signal from an external electronic device, for example music, and for generating an acoustical, optionally visual, representation. The method, comprising outputting bass tones and outputting treble tones. The method, further comprising processing binaural audio.

A multimedia transporter system comprising a multimedia transporter, and a modular piano keyboard, the modular piano keyboard comprising at least one keyboard module, and optionally, a pedal module.

The system, wherein the modular piano keyboard comprises several modules totaling 87 piano keys and 2 piano pedals. The system, wherein, in the disassembled state, the various modules of the modular piano keyboard are housed within the multimedia transporter, facilitating their transport, charging, and configuration. The system, wherein, in the assembled state, the various modules of the modular piano keyboard are located outside the multimedia transporter, and since they are connected to each other, generate signals once the keys or pedals are pressed, which are received and transformed into acoustic, optionally visual, representations by the multimedia transporter. The system, wherein the multimedia transporter is configured to transmit the music signals to any external device or social platform on the Internet. The system, wherein the multimedia transporter is configured to play, through the loudspeaker, music received from any external device, also, at the same time, playing signals from the modular piano keyboard.

A method in a multimedia transporter system comprising a multimedia transporter, and a modular piano keyboard, the modular piano keyboard comprising at least one keyboard module, and optionally, a pedal module.

A computer program comprising instructions, once executed on a processor, for carrying out the method steps.

A computer-readable medium comprising instructions, once executed on a processor, for carrying out the method steps.

1. A multimedia transporter for housing a modular piano keyboard, the modular piano keyboard comprising one or more members including at least one keyboard member, and optionally, a pedal member, the multimedia transporter comprising:
a frame;
at least one first housing configured to house the at least one keyboard member;
at least one second housing configured to house the at least one pedal member;
communication interface configured to communicate with the at least one keyboard and/or pedal member, and also configured to communicate with at least one external electronic device;
a graphical interface configured for visual representations upon playing the keys and/or pedals, and/or upon receiving signals from at least one external electronic device;
a loudspeaker configured for acoustic representations upon playing the keys and/or pedals, and/or upon receiving signals from at least one external electronic device.

2. The multimedia transporter of claim 1, further comprising a charger configured to conduct electrical power to at least one housed member.

3. The multimedia transporter of claim 1, further comprising input interface for receiving configuration orders or instructions from a user.

4. The multimedia transporter of claim 3, further comprising a processor configured for updating an intensity, frequency, or phase, parameters, of a sound, of each of the members being housed.

5. The multimedia transporter of claim 1, further comprising a processor configured for receiving a signal generated by the one or more members of the modular piano keyboard in a disassembled state, and for generating an acoustic, optionally visual, representation of actions of a user playing the modular piano keyboard.

6. The multimedia transporter of claim 5, wherein the processor is also configured for receiving a signal from an external electronic device, for example music, and for generating an acoustical, optionally visual, representation.

7. The multimedia transporter of claim 1, wherein the loudspeaker is configured for outputting bass tones, also known as subwoofer, and for outputting treble tones.

8. The multimedia transporter of claim 1, further comprising a binaural audio processor.

9. A method in a multimedia transporter of claim 1, the multimedia transporter configured for housing a modular piano keyboard, the modular piano keyboard comprising at least one keyboard member, and optionally, a pedal member, the method comprising:
communicating with the at least one keyboard and/or pedal member, and also with at least one external electronic device;
visually representing, by a graphical interface, upon playing the keys and/or pedals, and/or upon receiving signals from the at least one external electronic device;
acoustically representing, by a loudspeaker, upon playing the keys and/or pedals, and/or upon receiving signals from the at least one external electronic device.

10. The method of claim 9, further comprising conducting electrical power to at least one housed member.

11. The method of claim 9, further comprising receiving configuration orders or instructions from a user.

12. The method of claim 11, further comprising updating an intensity, frequency, or phase, parameters, of a sound, of each of the members being housed.

13. The method of claim 9, further comprising receiving a signal generated by the one or more members of the modular piano keyboard in a disassembled state and for generating an acoustic, optionally visual, representation of actions of a user playing the modular piano keyboard.

14. The method of claim 13, comprising receiving a signal from an external electronic device, for example music, and for generating an acoustical, optionally visual, representation.

15. The method of claim 9, comprising outputting bass tones and outputting treble tones.

16. The method of claim 9, further comprising processing binaural audio.

17. A multimedia transporter system comprising a multimedia transporter and a modular piano keyboard, the modular piano keyboard comprising at least one keyboard member, and optionally, a pedal member, the multimedia transporter comprising a loudspeaker configured for acoustic representations upon playing the keys and/or pedals, and/or upon receiving signals from at least one external electronic device, and further comprising:
a frame;
at least one first housing configured to house the at least one keyboard member;
at least one second housing configured to house the at least one pedal member;
communication interface configured to communicate with the at least one keyboard and/or pedal member, and also configured to communicate with at least one external electronic device; and
a graphical interface configured for visual representations upon playing the keys and/or pedals, and/or upon receiving signals from at least one external electronic device.

18. The system of claim 17, wherein the modular piano keyboard comprises several members totaling 87 piano keys and 2 piano pedals.

19. The system of claim 17, wherein, in a disassembled state, various members of the modular piano keyboard are housed within the multimedia transporter, facilitating their transport, charging, and configuration.

20. The system of claim 17, wherein, in an assembled state, various members of the modular piano keyboard are located outside the multimedia transporter, and since they are connected to each other, generate signals once the keys or pedals are pressed, which are received and transformed into acoustic, optionally visual, representations by the multimedia transporter.

21. The system of claim 20, wherein the multimedia transporter is configured to transmit music signals to any external device or social platform on the Internet.

22. The system of claim 17, wherein the multimedia transporter is configured to play, through the loudspeaker, music received from any external device, also, at the same time, playing signals from the modular piano keyboard.

23. A method in a multimedia transporter system comprising a multimedia transporter and a modular piano keyboard, the modular piano keyboard comprising at least one keyboard member, and optionally, a pedal member, the multimedia transporter comprising a loudspeaker configured for acoustic representations upon playing the keys and/or pedals, and/or upon receiving signals from at least one external electronic device, and further comprising:
a frame;
at least one first housing configured to house the at least one keyboard member;
at least one second housing configured to house the at least one pedal member;
communication interface configured to communicate with the at least one keyboard and/or pedal member, and also configured to communicate with at least one external electronic device; and
a graphical interface configured for visual representations upon playing the keys and/or pedals, and/or upon receiving signals from at least one external electronic device.

24. (canceled)

25. A non-transitory computer-readable medium comprising instructions, once executed on a processor, cause the processor to perform operations including:
communicating with the at least one keyboard and/or pedal member, and also with at least one external electronic device;
visually representing, by a graphical interface, upon playing the keys and/or pedals, and/or upon receiving signals from the at least one external electronic device;
acoustically representing, by a loudspeaker, upon playing the keys and/or pedals, and/or upon receiving signals from the at least one external electronic device.
